(19) United States
(12) Patent Application Publication
(10) Pub. No.: US 2013/0180930 A1
(43) Pub. Date: Jul. 18, 2013

(54) METHOD AND APPARATUS FOR RECOVERING SPILLED OIL FROM BODIES OF WATER

(71) Applicant: Bradley William Warner, Bloomfield, MO (US)

(72) Inventor: Bradley William Warner, Bloomfield, MO (US)

(73) Assignee: Warner Enterprises, LLC, Bloomfield, MO (US)

(21) Appl. No.: 13/349,019

(22) Filed: Jan. 12, 2012

(51) Int. Cl. E02B 15/00; C02F 1/00; C02F 101/32

(52) U.S. Cl. 210/747.6; 210/170.01; 210/170.05; 210/747.5

(57) ABSTRACT

A boat is provided with a pipe assembly operatively connected to a water pump. The pipe assembly can be raised and lowered between transport and use positions. The pump draws water from the body of water, and the water is discharged through a series of holes in a substantially horizontal pipe adjacent the bottom of the body of water. The impingement of the ejecting water dislodges oil or other substances, which then float to the surface for collection.

### BACKGROUND OF THE INVENTION

Oil spills create immense environmental and ecological problems, with huge costs and difficulties for cleanup, which is often ineffective and insufficient. Oil spills on waterways creates additional complications when the oil sinks to the bottom of the bodies of water. While there is a variety of equipment used to recover spilled oil on the surface of the water, there is very little effective and efficient equipment and options available for recovering oil from the bed or floor of the body of water.

Several methods have been used to recover oil from the bottom of waterways. the most effective method, though not efficient, is diver-directed pumping. This method requires divers to crawl along the bottom of the body of water with a vacuum to suck up the oil. However, the vacuum inherently also sucks in water with the oil, which slows the rate of oil collection. Also, divers are limited in the size and length of hoses which they can handle. Thus, diver-directed pumping is slow and labor intensive. Also, long-term diving operations are inherently dangerous and becomes more so as the water depth increases.

Dredges have also been used to recover oil from the bottom of waterways. Clam shell dredges have been useful when the oil is solidified. Hopper dredges have been proposed, but generate massive volumes of water and sediment compared to the volume of oil recovered. The amount of water and sediment may be reduced using modifications to a large duckbill dredge head. Also, small dredges using centrifugal vane pumps and rotating cutter heads have successfully recovered submerged oil. Decanting systems have also been used to recover underwater oil, but also collect water which must be decanted, which is a limiting factor in the oil recovery operation.

Remotely operated vehicle pumping systems have been utilized for recovering oil from tanks of sunken vessels. However, such vehicles generally have not been used to pump oil from the sea floor.

Accordingly a primary objective of the present invention is the provision of a method and means of recovering oil and other substances from the bottom of bodies of water.

Another objective of the present invention is the provision of a device for dislodging substances, such as oil, from the floor or bed of waterways.

A further objective of the present invention is the provision of a method for dislodging oil and other substances from the floor or bed of waterways.

Yet another objective of the present invention is the provision of a method and means of directing jets of water onto the water body floor to dislodge sunken oil from the floor, which will float to the surface for recovery.

Another objective of the present invention is the provision of an apparatus mounted on a boat or float for impinging the bottom of the water body with water jets to loosen sunken oil, which will then float to the surface for recovery.

A further objective of the present invention is the provision of a method and means for pumping water to the bottom of a body of water to dislodge submerged substances, such as oil, for later recovery.

Still another objective of the present invention is the provision of an economical, efficient, and effective method and means for recovering spilled oil from the bottom of a body of water.

These and other objectives will become apparent from the following description of the invention.

### SUMMARY OF THE INVENTION

A method and means is provided for recovering spilled oil, or other substances, which has settled on the bottom of a body of water. The method and means utilizes a boat having a pump with an inlet residing in the body of water. The outlet of the pump is connected to a pipe which can be lowered from the boat to a position adjacent the bottom of the body of water. The pipe includes a series of holes. The pump supplies water from the body of water to the pipe for ejection out the holes so as to impinge the floor or bed of the body of water and thereby dislodge the settled oil, which then floats back to the surface of the body of water, where the oil can be can be collected using conventional surface cleaning equipment.

### BRIEF DESCRIPTION OF THE DRAWINGS

FIG. 1 is a side elevation view of a boat having the oil reclamation apparatus of the present invention mounted thereon and lowered to a use position.

FIG. 2 is a side elevation view similar to FIG. 1, showing the oil recovery device in a raised, non-use position.

FIG. 3 is a top plan view of the boat with the oil reclamation device of the present invention.

FIG. 4 is a rear end view of the boat, with the oil reclamation apparatus moved to the lowered, use position. FIG. 5 is an enlarged view taken along lines 5-5 of FIG. 1.

### DETAILED DESCRIPTION OF THE PREFERRED EMBODIMENTS

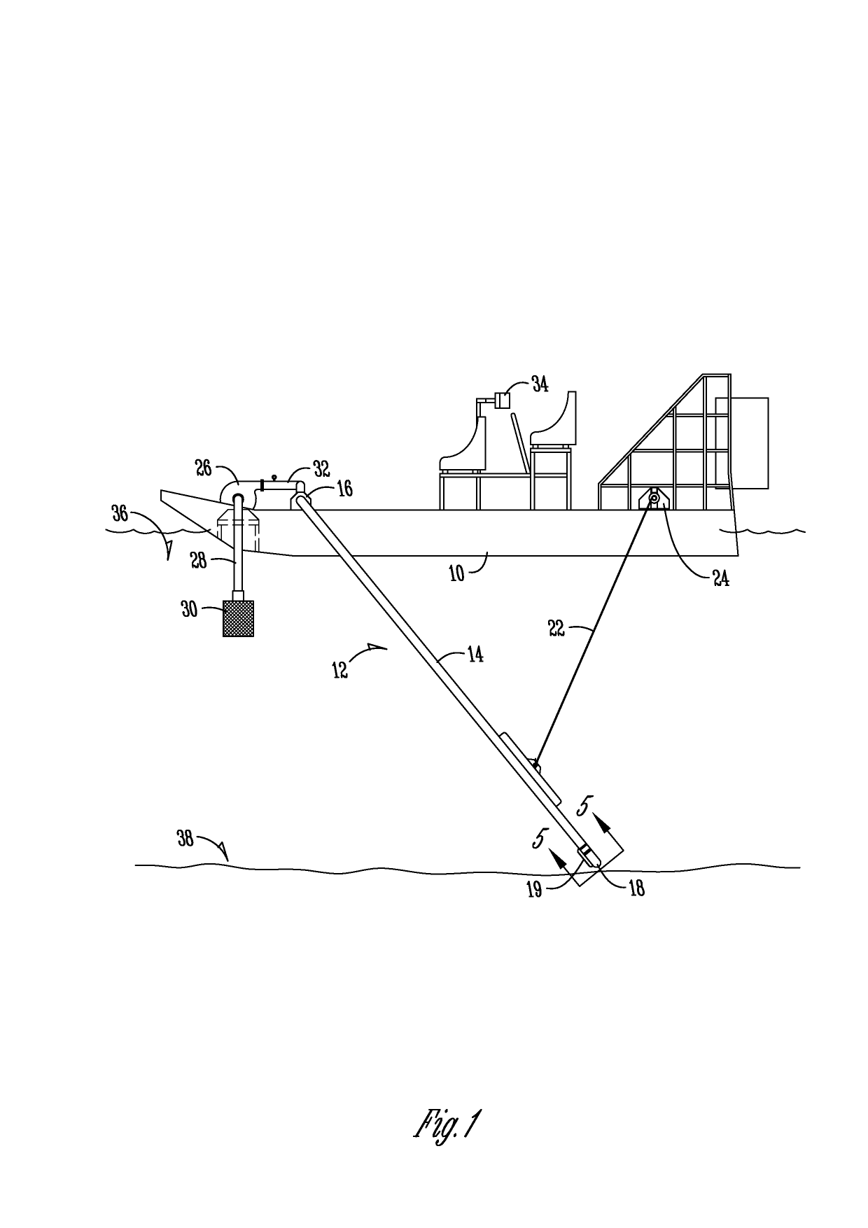

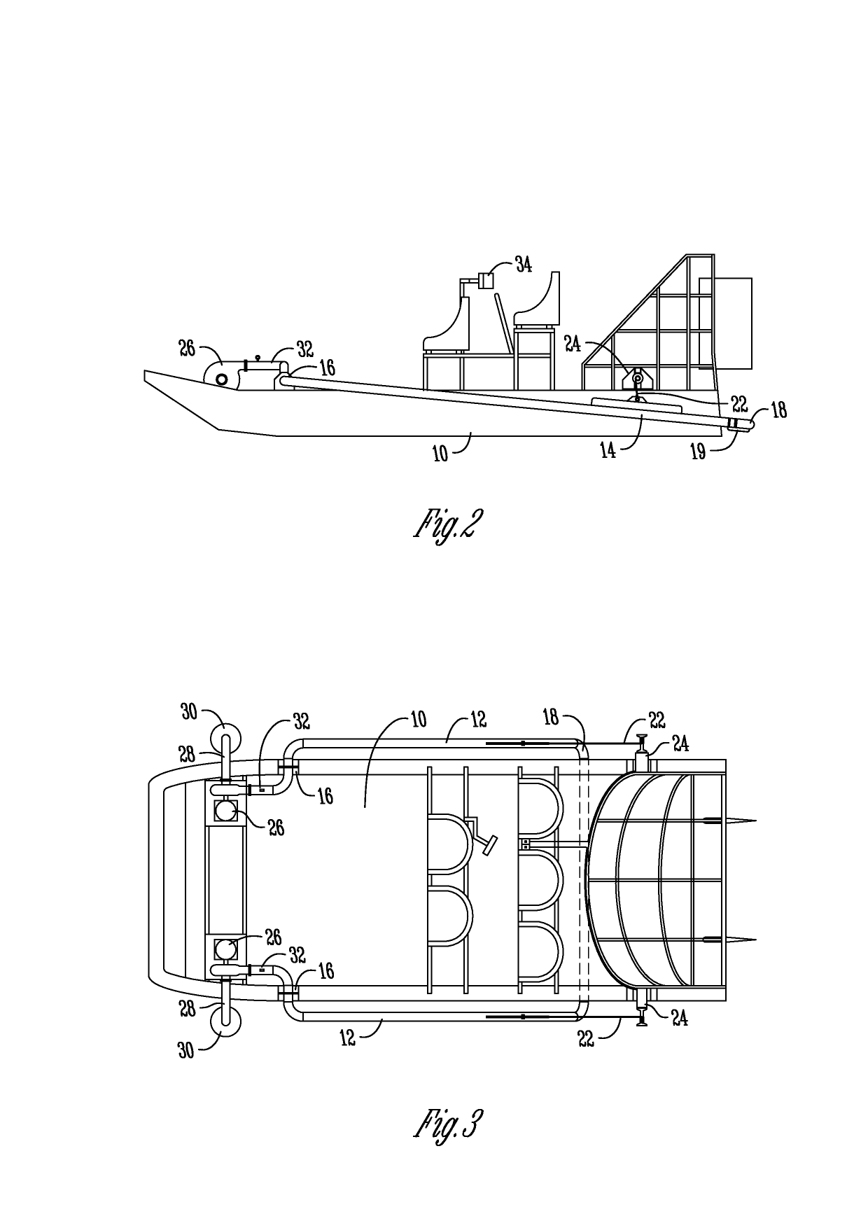

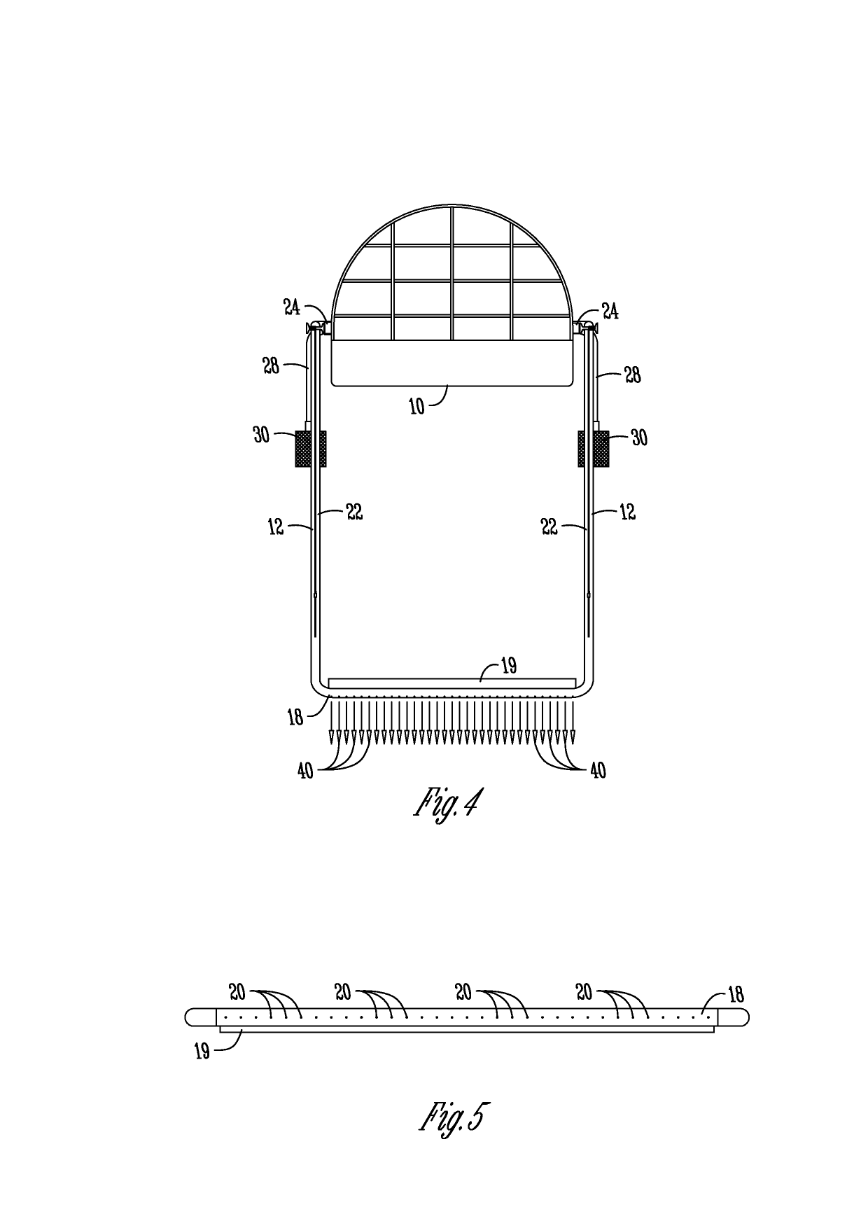

The present invention provides a device and method for dislodging oil or other substances which have settled on the floor or bed of a water body so that the oil or substance can be recovered and collected. More particularly, a boat 10 or other floating device supports an assembly 12 which can be moved between a lowered use position, as shown in FIG. 1, and a raised non-use position, as shown in FIG. 2. The assembly 12 includes a pair of opposite arms 14 having upper ends pivotally mounted in a pair of support brackets 16 mounted on the deck of the boat 10. A pipe 18 having a plurality of holes 20 extends between the lower ends of the arms 14. At least one of the arms comprises a hollow pipe. The arms 14 form a frame to support the pipe 18 in a substantially horizontal position. A cable or wire 22 has a first or lower end connected to each of the arms 14, and an upper end connected to a winch 24 or other lifting actuator for winding and underlining the cable 22, such that the pipe 18 can be moved between the raised and lowered positions. The winch 24 may be powered by a motor or manually operated with a crank. A control system may be provided if the winch 24 is motorized.

One or more pumps 26 are mounted on the deck of the boat 10. An inlet pipe 28 is removably connected to each pump 26, and has a lower end which can be positioned in the body of water below the surface. A filter or strainer 30 preferably is provided on a lower end of the inlet pipe 28 so as to prevent objects from being drawn into the pump 26. An outlet pipe 32 extends from the pump 26 to the upper end of the hollow arm or arms 14 so as to supply water to the pipe 18 for ejection through the holes 20.

Boat 10 may also include a sonar path tracker unit 34 for monitoring the position of the boat.

The boat 10 is shown to be a flat bottomed air boat. However, it is understood that other types of boats may be utilized, as well as a raft or other floats to support the pipe assembly 12 and pump 26.

In operation, the boat 10 is navigated to a desired location on the body of water 36, and then the pipe assembly 12 is lowered from the transport position shown in FIG. 2 to the operative position shown in FIG. 1. The pipe 18 is lowered to a substantially horizontal position adjacent the bottom 38 of the body of water. The pump or pumps 26 are then activated so as to draw water from the body of water through the strainer 30 and into the inlet pipe 28, and then through the outlet pipe 32 to the hollow arm or arms 14 and the pipe 18. The water is ejected from the holes 20 of the horizontal pipe 18 as represented by arrow 40 in FIG. 4, so as to impinge on the bottom 38 of the body of water 36, and thereby dislodge the oil or other substances, which will then float to the top of the water. Once the oil is on the surface, conventional equipment can be used to collect the oil, such as skimmer equipment. The boat 10 moves the pipe 18 along the floor or bed 38 in any convenient or desired pattern.

The method and means of the present invention can be used on any waterway or body of water where oil or other hazardous waste needs to be raised from the bottom for collection and removal. For example, the boat 10 with the assembly 12 can be used on rivers, lakes, and oceans where oil spills have occurred. The only energy needs are for operating the boat 10, the pump 26, and the winch 24. When the assembly 12 is not in use, the arms 14 and pipe 18 can be raised, and the pump inlet pipe 28 and strainer 30 can be removed or otherwise raised out of the water, as seen in FIG. 2, so that the boat can navigate in a normal manner.

The invention has been shown and described above with the preferred embodiments, and it is understood that many modifications, substitutions, and additions may be made which are within the intended spirit and scope of the invention. From the foregoing, it can be seen that the present invention accomplishes at least all of its stated objectives.

What is claimed is:

1. A device for dislodging substances from the bottom of a body of water, comprising:
a pipe with at least one outlet opening adapted to be positioned adjacent the bottom;
a pump having an inlet within the body of water and an outlet connected to the pipe;
whereby the pump draws in water from the body of water and delivers the water to the pipe for ejection through the outlet opening to impinge on the bottom and thereby dislodge substances from the bottom.

2. The device of claim 1 further comprising a float to support the pump and to which the pipe is attached.

3. The device of claim 2 wherein the float is a boat.

4. The device of claim 2 wherein the pipe is pivotally connected to the float for movement between raised and lowered positions.

5. The device of claim 4 further comprising a winch on the float to raise and lower the pipe.

6. The device of claim 1 further comprising a filter on an upstream side of the pump.

7. The device of claim 1 further comprising a lift to move the pipe between a raised position and a lowered position.

8. The device of claim 1 further comprising a frame to support the pipe in a generally horizontal orientation.

9. The device of claim 8 wherein the frame is hollow and extends between the pump and the pipe.

10. The device of claim 1 wherein the pipe includes a plurality of outlet openings along its length.

11. A method of dislodging a substance from the bottom of a body of water, comprising:
positioning a pipe having at least one discharge opening adjacent he bottom of the body of water;
pumping water from the body of water to the pipe for ejection from the discharge opening so as to impinge onto the bottom so as to dislodge substances from the bottom.

12. The method of claim 11 further comprising supporting the pipe in a substantially horizontal orientation.

13. The method of claim 11 further comprising moving the pipe between a lowered use position and a raised non-use position.

14. The method of claim 11 further comprising mounting the pipe on a float on the surface of the body of water.

15. The method of claim 11 further comprising mounting the pipe on a boat.

16. The method of claim 11 further comprising filtering the water before delivery to the pipe.

17. The method of claim 11 wherein the pipe is substantially parallel to the bottom of the body of water.

18. A method of recovering spilled oil which has settled onto the bottom of a body of water, the method comprising:
directing jets of fluid onto the bottom of the body of water so as to impinge upon the bottom and dislodge oil therefrom such that the oil floats to the surface of the body of water; and
collecting the oil off the surface of the water.

19. The method of claim 18 wherein the fluid is water pumped from the body of water to a pipe having a plurality of holes through which the water is ejected adjacent the bottom of the body of water.

20. The method of claim 19 wherein the pipe is mounted on a boat for pivotal movement between a raised transport position and a lowered use position.
